(19) United States
(12) Patent Application Publication
(10) Pub. No.: US 2002/0159151 A1
(43) Pub. Date: Oct. 31, 2002

(54) Optical interleaver using mach-zehnder interferometry

(76) Inventor: Jim W. Li, Fremont, CA (US)

Correspondence Address: JOSHUA D. ISENBERG, 204 CASTRO LANE, FREMONT, CA, 94539, US

(21) Appl. No.: 09/793,456

(22) Filed: Feb. 26, 2001

(51) Int. Cl. G02B 5/30

(52) U.S. Cl. 359/498

(57) ABSTRACT

An optical interleaver apparatus and method are disclosed. The interleaver apparatus generally includes a linear polarizer, a polarization rotator, and a Mach-Zehnder interferometer. The linear polarizer polarizes the input signal, if it is not already polarized. The polarization rotator rotates the input signal such that the Mach-Zehnder interferometer splits the rotated signal into two parts of equal intensity. The Mach-Zehnder introduces a phase difference between the two parts and then recombines the two parts so that they interfere. With a proper choice of the phase difference the two parts of the input signal interfere such that signal channel components in different frequency ranges have complementary polarizations. The signal channel components may then be separated into two output signals according to their respective polarizations. A second Mach-Zehnder interferometer may optically be coupled to the first Mach-Zehnder interferometer to improves isolation between the odd and even channels and shapes the overall passband of the interleaver.

### FIELD OF THE INVENTION

This invention relates generally to optical communications systems. More particularly, it relates to optical interleavers.

### BACKGROUND ART

Optical wavelength division multiplexing (WDM) has gradually become the standard backbone network for fiber optic communication systems. WDM systems transmit information on optical fibers using a number of optical signals having different wavelengths, known as carrier signals or channels. Each carrier signal is modulated by one or more information signals. As a result, a significant number of information signals may be transmitted over a single optical fiber using WDM technology. The increasing demand for capacity in fiber optic networks requires more channels (wavelengths) to fit within a limited wavelength band. Consequently, the channel spacing in the passband of a WDM device should be made as narrow as possible. Several techniques are currently used for multiplexing and de-multiplexing WDM signals. However, as the channel spacing becomes narrower these techniques suffer from inherent technical limitations that make it difficult to separate narrowly spaced channels. Current WDM technologies can only provide stable operation at channel separations of about 100 gigahertz (GHz) or greater.

For example, the bandwidth of WDM systems based on thin film wavelength filters is limited by thin film coating technology. WDM systems based on fiber gratings suffer from temperature sensitivity problems that become particularly pronounced at dense channel spacing, i.e., less than 100 GHz. To address these problems WDM systems often use components referred to generically as optical interleavers to combine, split, or route optical signals of different channels. An interleaver is a device that divides alternate channels into two groups, sometimes referred to as even or odd. Since each group carries only alternate channels, the frequency spacing for channels in each group is effectively doubled. Conventional WDM modules may then be used at subsequent stages to further separate the WDM signals.

Interleavers are typically based either on multi-order waveplates or an interferometry technique. Optical interleavers that use multi-order waveplates are described, for example, in U.S. Pat. Nos. 5,694,233 and 5,912,748. The key component in such an interleaver is a wavelength filter made from multi-order waveplates. The wavelength filter is characterized by wavelength-selective polarization rotation. Such a filter provides a transmission function such that the polarization of the odd channels is orthogonal to the polarization of the even channels. The odd and even channels may then be separated by polarization selective elements such as birefringent crystals or polarizing beam splitters. Waveplate type optical interleavers provide good performance for sufficiently wide channel spacing, e.g. 100 GHz or greater. Unfortunately, channel spacing is inversely proportional to the length of the wavelength filter. Thus, as channel-to-channel spacing decreases to accommodate more channels, the wavelength filter and the interleaver itself must be made longer. For example, yttrium orthovanadate (YVO₄) is commonly used in multi-order waveplates due to its relatively large refractive index difference between ordinary and extraordinary polarized light (nₑ−nₒ=0.204). To separate channels spaced 50 GHz apart with a two-stage interleaver the YVO₄ crystal in the wavelength filter is 14.7 mm long in the first stage and 29.4 mm long in the second stage. For a channel spacing of 25 GHz, the crystal lengths are doubled. Such large crystals add undesirably to the bulk, mass and cost of the interleaver. Furthermore, such large crystals present problems with packaging and thermal stability.

An example of an interferometer-based interleaver is described in U.S. Pat. No. 6,130,971. This interleaver utilizes a beam splitter and two Gires-Tournois etalon type phase modulators to create a phase difference between two beams. Though this interleaver produces flat-topped transmission peaks with good channel isolation, the manufacturing tolerances for the etalon resonant cavity are very stringent. Furthermore, in this interleaver, a half-wave plate is inserted inside the cavity. Variations in the length and refractive index of this wave plate with temperature must be compensated, which adds to the complexity of the interleaver.

A key problem with such interleavers is compensation of changes in optical path due to change in temperature. When the temperature of an interferometer changes, both the refractive index and physical path length change. These changes can affect the optical path difference between the two arms of the interferometer and thereby affect channel isolation of the interleaver. Prior art attempts to compensate for temperature changes have been based on using an etalon or a compound optical element. In the etalon design, two spacer elements expand side by side in the same direction such that the difference between their lengths remains fixed. The etalon design tends to be somewhat complex and delicate. In the compound element design, to optical elements placed end to end respond to changes in temperature such that an increase in optical path in one element compensates for a decrease in optical path through the other. The compound element design tends to be somewhat bulky.

There is a need, therefore, for an improved optical interleaver that overcomes the above difficulties.

### SUMMARY

The interleaver apparatus generally includes a polarization selective element, a polarization rotator optically coupled to the polarization selective element, and a Mach-Zehnder interferometer optically coupled to the polarization rotator. The polarization selective element polarizes the input signal, if it is not already polarized. The polarization rotator alters the polarization states of the linearly polarized signal. The Mach-Zehnder interferometer splits the polarization rotated signal into two parts having equal intensity, introduces a phase difference between the two parts, and recombines the two parts so that they interfere. With a proper choice of the phase difference the two parts of the input signal interfere such that signal channel components in different frequency ranges have complementary polarizations. The signal channel components may then be separated into two output signals according to their respective polarizations. The Mach-Zehnder interferometer may be configured such that an optical path difference between two arms of the interferometer remains substantially constant over a predetermined temperature range.

According to a first embodiment, the interleaver comprises a first birefringent element as the polarization selective element, a half waveplate coupled optically to a quarter waveplate as the polarization rotator, and a Mach-Zehnder interferometer having a refractive element optically coupled between second, and third birefringent elements. The first birefringent element has an optic axis oriented to split the input optical signal into ordinary and extraordinary beams having complementary polarizations. The half waveplate optically rotates the polarization of one of the ordinary and extraordinary beams so that they have the same polarization. The quarter waveplate is optically coupled to the first birefringent element. The quarter waveplate has fast and slow axes oriented to circularly polarize the ordinary and extraordinary beams. The second birefringent element is optically coupled to the quarter waveplate. The second birefringent element has an optic axis oriented such that the second birefringent element separates the circularly polarized ordinary beam into first and a third linearly polarized beams having complementary polarizations. The second birefringent element similarly separates the extraordinary beam into second and fourth beams having complementary polarizations.

The refractive element introduces an optical path difference between the first beam and the third beam and an optical path difference between the second beam and the fourth beam. The optical path difference introduces a frequency dependent phase difference between one or more channels in the first and third beams. Similarly, the optical path difference causes a frequency dependent phase difference between one or more channels in the second and fourth beams. The refractive element may be a refractive plate having a thickness, refractive index, and temperature coefficients of expansion and refraction chosen to passively compensate for changes in temperature. The refractive plate may optionally include an electro-optical element with a feedback mechanism to actively compensate for the effects of changes in temperature.

The third birefringent element combines the first and third beams to form a fifth beam and similarly combines the second and fourth beams to form a sixth beam. The frequency dependent phase difference produces interference in the fifth and sixth beams such that even and odd channels in the fifth and sixth beams have complementary polarizations. The interleaver may include a polarization dependent router for separating the even and odd channels to form even and odd output signals.

According to a second embodiment of the present invention, the interleaver further includes a second Mach-Zehnder interferometer optically coupled to the first Mach-Zehnder interferometer. The second interferometer improves isolation between the odd and even channels and shapes the overall passband of the interleaver. The second Mach-Zehnder interferometer may also be configured such that an optical path difference between two arms of the interferometer remains substantially constant over a predetermined temperature range.

Interleavers constructed in accordance with embodiments of the present invention can exhibit good isolation between odd and even channels spaced 50 GHz apart while providing temperature stable operation.

### BRIEF DESCRIPTION OF THE FIGS.

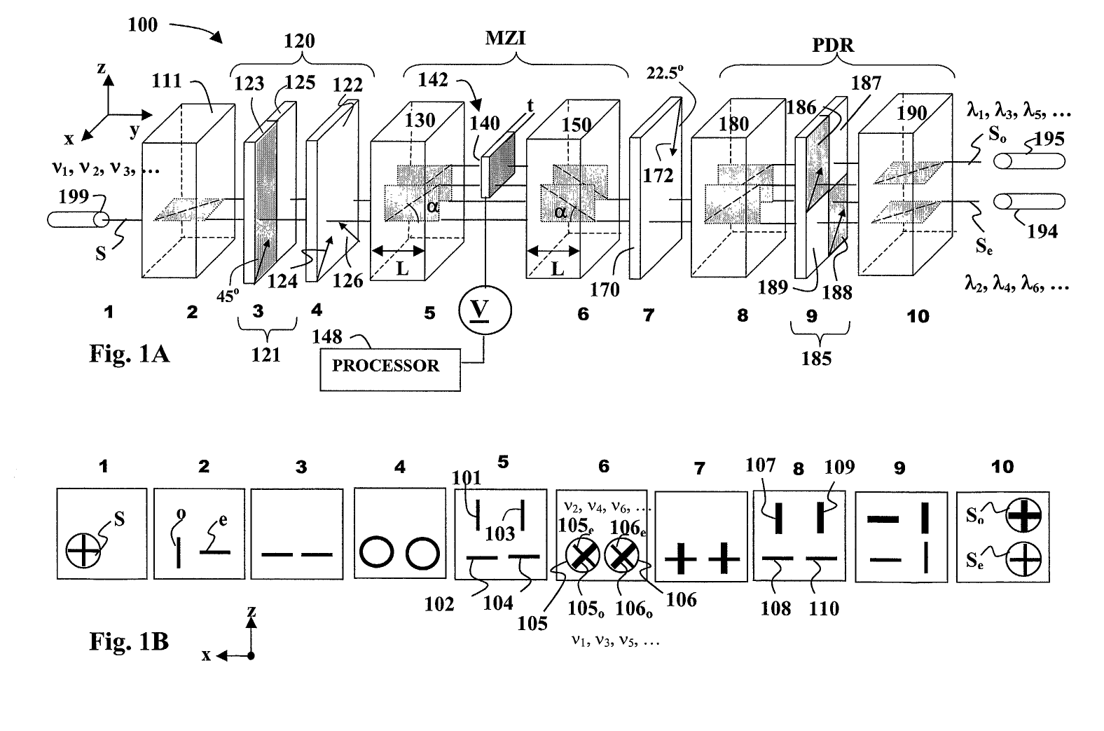

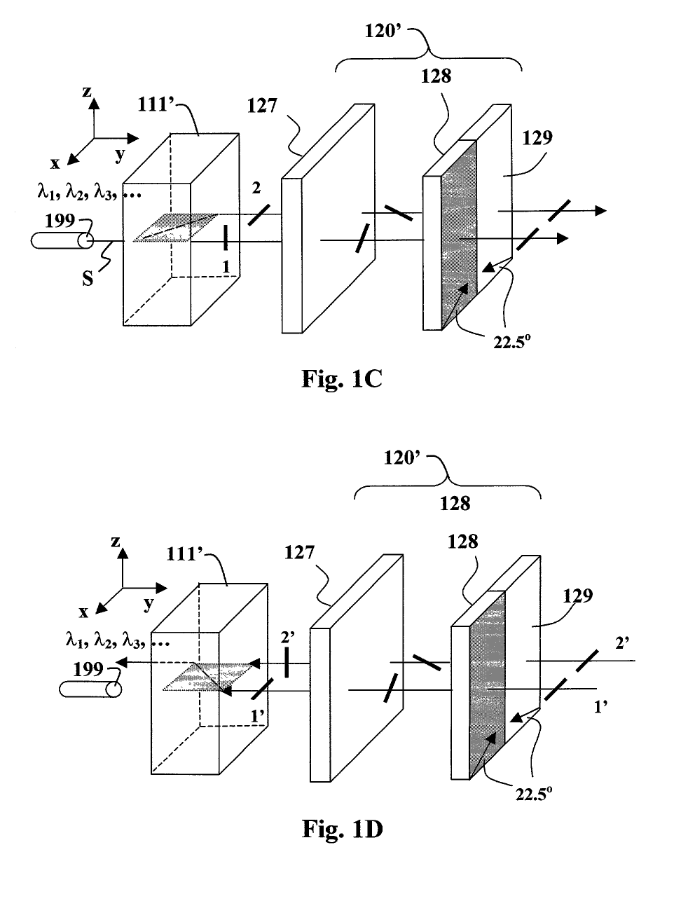

FIG. 1A depicts a simplified isometric diagram of a single stage optical interleaver according to a first embodiment of the present invention;

FIG. 1B depicts a series of cross sectional schematic diagrams illustrating the polarization state of optical signals at selected locations along the interleaver of FIG. 1A;

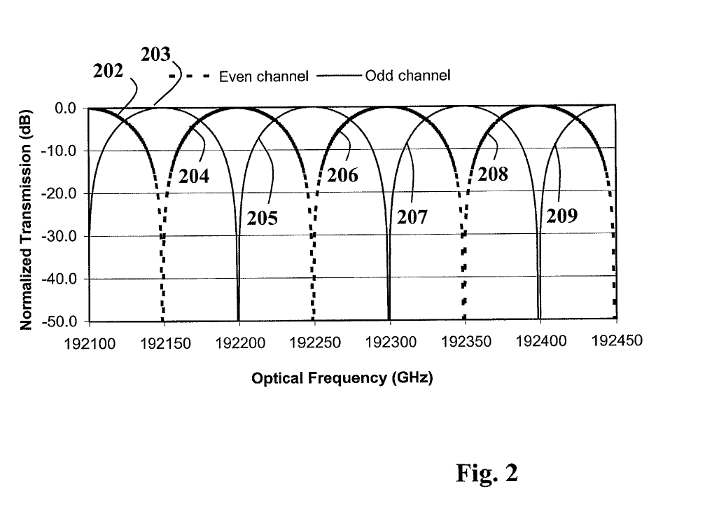

FIG. 2 depicts a graph depicting a theoretical normalized transmission versus optical frequency for an interleaver according to the first embodiment of the invention

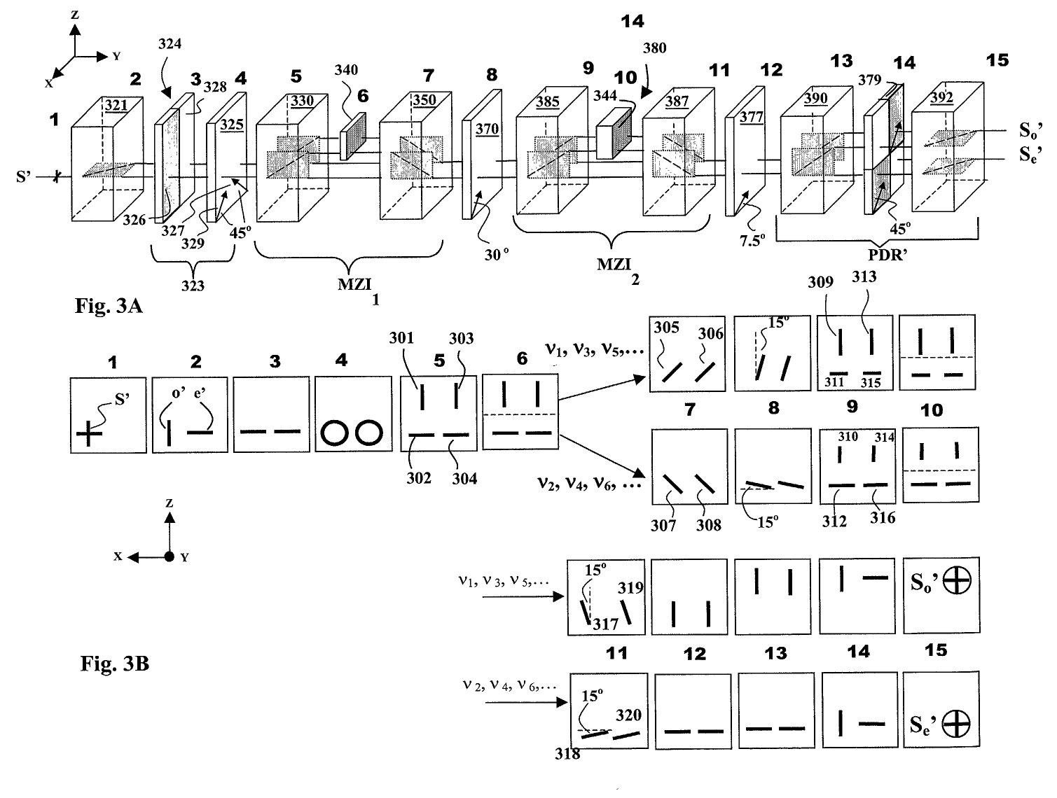

FIG. 3A depicts an simplified isometric diagram of a dual stage optical interleaver according to a second embodiment of the present invention;

FIG. 3B depicts a series of cross sectional schematic diagrams illustrating the polarization state of optical signals at selected locations along the interleaver of FIG. 2A;

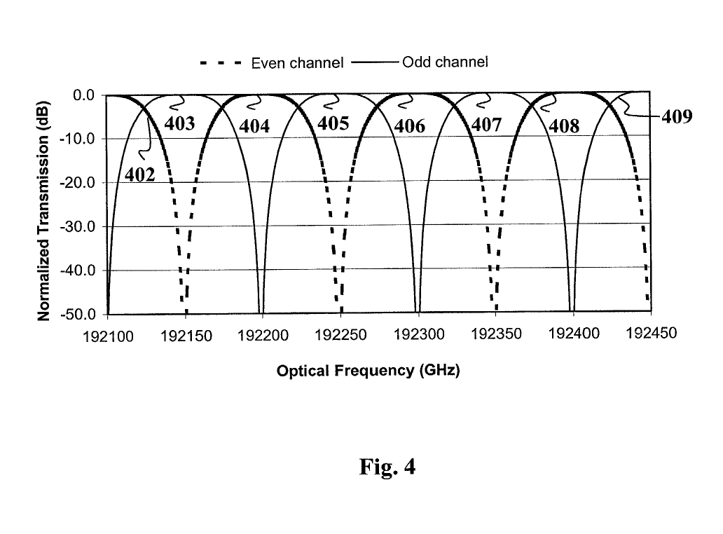

FIG. 4 depicts a graph depicting a theoretical normalized transmission versus optical frequency for an interleaver according to the second embodiment of the invention; and

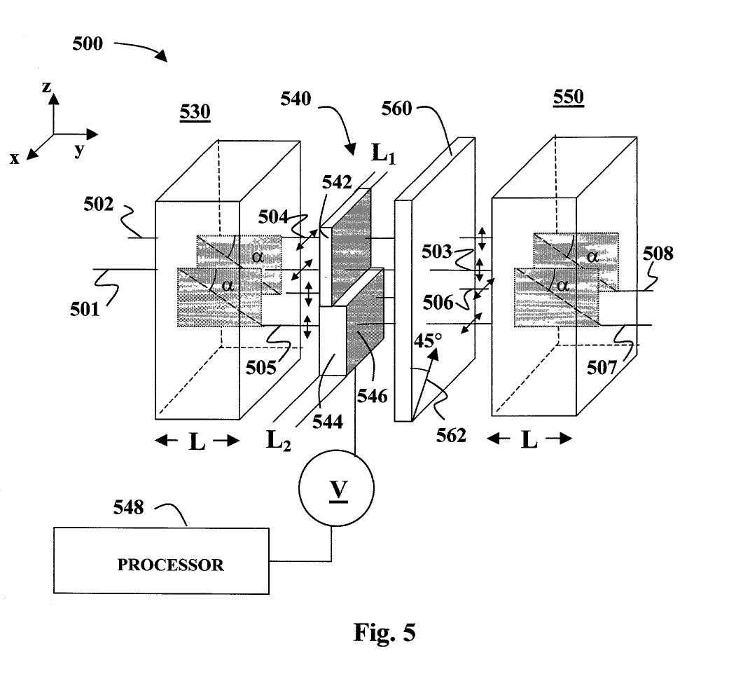

FIG. 5 depicts a simplified isometric schematic diagram of an alternative Mach-Zehnder interferometer that may be used in interleavers according to the first and second embodiments of the invention.

### DETAILED DESCRIPTION

Although the following detailed description contains many specifics for the purposes of illustration, anyone of ordinary skill in the art will appreciate that many variations and alterations to the following details are within the scope of the invention. Accordingly, the following preferred embodiment of the invention is set forth without any loss of generality to, and without imposing limitations upon, the claimed invention.

FIG. 1A depicts an interleaver 100 according to a first embodiment of the invention. The interleaver 100 generally comprises a polarization selective element 111 optically coupled to a polarization rotator 120, which is optically coupled to a Mach-Zehnder interferometer MZI. In the embodiment shown in FIGS. 1A-1B, the Mach-Zehnder interferometer MZI has a refractive element 140 disposed between second and third birefringent elements 130, 150. The interleaver 100 may also include a polarization dependent router PDR optically coupled to the Mach-Zehnder interferometer MZI. In FIGS. 1A-1B, a y-axis refers to a direction substantially parallel to a direction of travel of optical signals through the interleaver 100 and x- and z-axes are substantially perpendicular to the y-axis and to each other.

The method of operation of the interleaver 100 is best understood by referring simultaneously to FIG. 1A and the polarization diagrams at selected numbered cross sections depicted in FIG. 1B. One or more un-polarized signals S are incident on the polarization selective element 111 from a first input/output (I/O) port 199. The unpolarized signal S typically includes both vertical and horizontal components as shown in cross-section 1. The WDM signal S typically contains one or more odd channels characterized by frequencies ν₁, ν₃, ν₅ . . . (or wavelengths λ₁, λ₃, λ₅, . . . ) and/or one or more even channels characterized by frequencies ν₂, ν₄, ν₆, . . . (or wavelengths λ₂, λ₄, λ₆, . . . ) etc. The even and odd channels are typically equally spaced by some common channel spacing δν. If the WDM signal S is a dense WDM signal, the channel spacing between adjacent channels is less than about 100 GHz. By way of example, the odd channels may be characterized by carrier signal frequencies ν₂ₘ₊₁=(2m+1) δν and the even channels are characterized by carrier signal frequencies ν₂ₘ=2mδν, where m is an integer. The odd and even channels alternate such that a given odd channel is separated from the nearest odd channels by a 2δν. Even channels are similarly spaced by 2δν. Neighboring odd and even channels, however, are spaced apart by the channel spacing of δν.

In the embodiment depicted in FIGS. 1A-1B the polarization selective element 111 is a first birefringent element. Polarizers based on birefringent walk-off elements are often desirable in interleaver 100 because it is possible to recapture nearly all of the intensity of the incident signal S. Other beam splitting birefringent polarizers, such as Nichol prisms, Glan, Thompson, Rochon or Wollaston prisms or polarizing beam splitters may alternatively be used as the polarization selective element 111. It is also possible to use linear polarizers such as Glan-Taylor or Glan-Thompson prisms, dichroic polarizers, Polaroid materials, Brewster's angle reflectors, or other linear polarizers as the polarization selective element, albeit at the cost of about 50% of incident signal intensity. By way of example, polarization selective element 111 is a first birefringent element having an optic axis oriented to separate the WDM signal S into a vertically polarized ordinary beam o and horizontally polarized extraordinary beam e as indicated by cross-section 2 of FIG. 1B.

The ordinary and extraordinary beams o, e optically couple to the polarization rotator 120. As used herein, the term polarization rotator includes all devices that rotate or circularize the polarization of optical signals. Such devices include half waveplates, quarter waveplates, magneto optic devices such as Faraday rotators, liquid crystals, twisted nematic crystals, electro-optic elements and the like. In the embodiment shown in FIG. 1A the polarization rotator 120 includes a waveplate 121 coupled to a quarter waveplate 122. The waveplate 121 includes a half waveplate section 123 and a phase compensation section 125. The half waveplate 123 rotates the polarization of the ordinary beam o so that the ordinary and extraordinary beams have the same polarization as shown in cross-section 3. This is desirable to ensure that the quarter waveplate 122 circularly polarizes both beams in the same sense of rotation. The quarter waveplate 122 has its fast-axis 124 and slow-axis 126 at 45° with respect to the ordinary beam o and the extraordinary beam e. Consequently the extraordinary beam e and the ordinary beam o become circularly polarized as shown in cross-section 4.

Although the polarization rotator 120 is described herein as including a quarter waveplate that produces circularly polarized light, the embodiment depicted in FIG. 1 may also work, for example, if the polarization rotator 120 rotates the polarizations of the ordinary and extraordinary beams by 45° such that they are linearly polarized parallel to each other. In such a case, the polarization rotator may include a half waveplate and/or faraday rotator to rotate the polarizations by 45°. Furthermore, the polarization rotator 120 may optionally include a non-reciprocal rotator such as a Faraday rotator in conjunction with two half waveplates to prevent reflected optical signals from coupling back into the first I/O port 199.

The operation of a non-reciprocal polarization rotator 120′ is depicted in FIGS. 1C-1D. The non-reciprocal polarization rotator 120′ generally comprises a Faraday rotator 127 optically coupled to two half waveplates 128, 129. On a forward path, shown in FIG. 1C, the Faraday rotator 127 rotates the polarizations of beams 1 and 2 clockwise by 45°. Half-waveplate 128 is aligned with its optical axis at 112.5° with respect to x-axis. Thus half-waveplate 1 further rotates the polarization of beam 1 clockwise by 45°. The net result of Faraday rotator 127 and half-waveplate 128 is to rotate the polarization of beam 1 clockwise by 90°. Half-waveplate 129 is aligned with its optical axis at 22.5°. with respect to x-axis. Thus half-waveplate 129 rotates beam 2 counter-clockwise by 45°. The net result of Faraday rotator 127 and half-waveplate 129 is to keep the polarization state of beam 2 unchanged.

On the reverse path shown in FIG. 1D, half-waveplate 128 rotates return beam 1′ clockwise by 45°. Faraday rotator 127 rotates beam 1′ clockwise by 45°. The net result of half-waveplate 128 and Faraday rotator 127 and is to keep the polarization of beam 1′ unchanged. Half-waveplate 129 rotates beam 2 counter-clockwise by 45°. Faraday rotator 127 further rotates beam 2′ clockwise by 45°. The net result of half-waveplate 129 and Faraday rotator 127 is to rotate beam 2′ by 90°. Due to polarization dependent refraction of birefrigent crystal 111′, the combined beam of 1′ and 2′ does not return to I/O port 199. Thus, the non-reciprocal polarization rotator 120′ provides optical isolation from optical signals that are reflected back toward the I/O port 199.

The quarter waveplate 122 is optically coupled to the Mach-Zehnder interferometer MZI at the second birefringent element 130. The second birefringent element 130 splits the o beam into two complementarily polarized portions 101, 102 of equal intensity. The second birefringent element 130 similarly splits the e beam into two complementarily polarized portions 103, 104. Each of the two complementary portions travels through a different arm of the interferometer MZI. The paths of beams 101, 103 constitute a first or sample arm of the Mach-Zehnder interferometer MZI. The paths of beams 102, 104 constitute a second or reference arm of the Mach-Zehnder interferometer MZI. In the embodiment shown, both birefringent elements 130, 150 and the refractive element 140 contribute to an optical path difference Δ between the two arms. The optical path difference Δ introduces a phase difference φ between the complementary portions and recombines them such that they interfere. Because of the phase difference and the frequency dependence of the interference, the odd and even channels end up with complementary polarizations as shown in cross section 6.

Although the Mach-Zehnder interferometer MZI depicted and described herein is built using birefringent walk-off elements 130, 150, other designs, e.g. using polarizing beam splitters in place of the birefringent elements, may alternatively be used. The second birefringent element 130 respectively divides the two circularly polarized beams o, e (or linearly polarized beams at 45° with respect to z-axis) into two pairs of equally intense complementarily polarized components, 101, 102, and 103, 104. As used herein, complementary polarizations include orthogonal linear polarizations as shown in cross section 4, as well as oppositely rotating circular polarizations.

The second birefringent element 130 has a thickness L. In the second birefringent element 130, beams 101, 103 are extraordinary rays subject to a refractive index nₑ. Beams 102, 104 are ordinary rays subject to refractive index nₒ For positive crystals such as YVO₄, nₑ>nₒ. The second birefringent element 130 refracts beams 101 and 102 at an angle α while transmitting beams 102, 104 substantially unrefracted. Beams 101 and 103 therefore take a longer optical path through the second birefringent element 130 than beams 102 and 104. Thus, the second birefringent element contributes an optical path difference Δ₁ between beams 101 and 102 and between beams 103 and 104 given by:

Δ₁=L[(nₑ/cosα)−nₒ]

In the embodiment shown in FIGS. 1A-1B, beams 101, 103 next pass through the refractive element 140 while beams 102, 104 bypass the refractive element 140. The refractive element 140 thus contributes an additional optical path difference Δ₂ between beams 101 and 103 and between beams 102 and 104. In its simplest form, the refractive element 140 may simply be a plate of transparent refractive material of thickness t placed in the path of beams 101 and 102. The refractive material may be glass or clear polymer characterized by a refractive index n. Beams 103 and 104 may pass through a free space gap characterized by a thickness t and a refractive index essentially equal to 1. In such a case, the path difference Δ₂ may be given by:

Δ₂=(n−1)t

The refractive element 140 is optically coupled to the third birefringent element 150. The third birefringent element 150 combines beam 101 with beam 102 to form beam 105 and beam 103 with beam 104 to form beam 106 as shown in cross section 6 of FIG. 1B. In the embodiment depicted in FIGS. 1A-1B the path through the third birefringent element 150 is longer for beams 101 and 103 than the path for beams 102 and 104. The third birefringent element 150 thus contributes yet another optical path difference between beams 101 and 102 and between beams 103 and 104. If the third birefringent element is made, e.g., from the same material as the second birefringent element and has the same thickness L the path difference Δ₃ due to the third birefringent element 150 may be given by:

Δ₃=L[(nₑ/cosα)−nₒ].

The optical path differences Δ₁, Δ₂, and Δ₃ are in general dependent on environmental temperature variation because both refractive indices and lengths tend to change with temperature. By judicious choice of the thickness for the birefringent elements 130 and 150, the thickness for the refractive element 140, and the material properties for the refractive element 140, which include the refractive index n, thermal coefficient of expansion (TCE), and the temperature coefficient of refraction dn/dT, it is possible to passively compensate for variations in optical path difference Δ due to changes in temperature. By way of example, for temperature compensation over a temperature range from ˜0° C. to ˜65° C. that limits drift in the passband of the interleaver 100 to about ˜3 GHz at a channel spacing δν of 50 GHz, if the birefringent elements 130, 150 are YVO₄ crystals of thickness ˜12 mm and refractive element 140 has a thickness between ˜1.0-˜2 mm, the preferred range for n is ˜1.45-˜1.73, the preferred range for TCE is ˜5-˜9.3 ppm/° C., and the preferred range for dn/dT is ˜0.5 to ˜5 ppm/° C. Shown in Table I are examples of potential glass materials from the two leading glass suppliers in the world.

TABLE I

| | SUPPLIER | |
|---|---|---|
| | Schott Glass Technologies | Ohara Corporation |
| | 400 York Avenue | 50 Columbia Road |
| | Duryea, PA 18642 | Somerville, NJ 08876 |
| MATE- | FK3, BK7, K3, LaF, | S-NSL3, S-NSL5, S-TIL6, |
| RIAL | LaK16A, LaK8, SK1 | S-BAL12, S-BAL3, S-TIL1 |

The materials listed in Table II represent particular examples of materials that are currently available. The invention is in no way limited to these particular materials.

The path difference Δ₂ through the refractive element 140 may also be actively adjusted in a number of ways. For example, the refractive element 140 may optionally include an electro-optic element 142 coupled to a voltage source V. The voltage source V may be coupled to a controller 148. An electric field within the electro-optic element, produced by the voltage source V controls the refractive index of the electro-optic-element. By means of a feedback circuit, or program, within the controller 148 the refractive index of the electro-optic element 142 may be adjusted to fine-tune the optical path difference to compensate for changes in temperature. Alternatively, the refractive element 140 may be an optical wedge or pair of optical wedges and the optical path difference Δ₂ may be adjusted by mechanically moving the wedge or wedges to change the length of the path optical signals take through the refractive element 140.

The total optical path difference Δ=Δ₁+Δ₂+Δ₃ produces the phase difference φ between beams 101 and 102 and between beams 103 and 104. The optical path difference Δ is related to a phase difference φ between the optical signals in beams 101, 102 and beams 103, 104. Generally φ is related to Δ by: φ=2πνΔ/c, where ν is the optical signal frequency and c is the speed of light in vacuum. Hence, the phase difference between optical signals in beams 101, 102 and beams 103, 104 is dependent on the signal frequency ν.

Because of the phase difference beams 101 and 102 interfere with each other and beams 103 and 104 interfere with each other. Due to the interference produced by the combination of beams 101, 102, and 103, 104, the polarization states of the even and odd channels in the combined beams 105, 106 depend on their optical frequencies. By proper choice of the thickness and refractive index of the refractive element the Mach-Zehnder interferometer MZI introduces a phase difference φ and provides interference that polarizes the odd and even channels in beams 105 and 106 in a complementary way. For example, as a result of a phase difference φ equal to 2mπ+π/2 radians, where m is an integer, even channels 105ₑ, 106ₑ in the combined beams 105, 106, e.g., channels having a frequency ν=νₑ=(2m+½)·c/2Δ are linearly polarized at −45° with respect to the z-axis as shown in cross-section 6. Similarly, odd channels 105_{O}, 106ₒ having a frequency ν=νₒ=(2m+3/2)·c/2Δ in the combined beams (105, 106) are also linearly polarized but tilted at 45° with respect to z-axis as shown in cross-section 6. The path difference Δ for a phase difference of π between adjacent channels may be determined from the channel spacing δν, and is given by Δ=c/2δν.

Once the odd and even channels have complementary polarizations, the polarization dependent router PDR may separate the odd and even channels according to their complementary polarizations in beams 105, 106 and form optical signals Sₒ, Sₑ containing respectively the odd and even channels. The polarization dependent router PDR may then route the optical signals Sₒ, Sₑ to I/O ports 194, 195.

The polarization dependent router PDR may include conventional components such as polarizing beam splitters and/or birefringent elements. In the embodiment depicted in FIG. 1A, the polarization dependent router PDR includes a second half waveplate 170, a fourth birefringent element 180, a polarization rotator 185, and a fifth birefringent element 190. The third birefringent element 150 is optically coupled to the second half waveplate 170. The second half waveplate 170 has an optic axis 172 oriented at 22.5° with respect to one of the polarization directions. In the embodiment shown, the optic axis is oriented at 22.5° with respect to the vertical direction of polarization (the z-axis). The second half waveplate 170 thus rotates the polarizations of the odd-channel components 105ₒ, 106ₒ, and even-channel components 105ₑ, 106ₑ counter-clockwise by 45° as shown in cross section 7.

The second waveplate 170 is optically coupled to the fourth birefringent element 180, which spatially separates the beams 105, 106 containing the odd channel components 105ₒ, 106ₒ and the even 105ₑ, 106ₑ channel components into odd-channel beams 107, 109 and even-channel beams 108, 110 as shown in cross section 8. The fourth birefringent element 180 is optically coupled to the fifth birefringent element 190. The fifth birefringent element 190 combines odd channel beams 107, 109 together to form a first output optical signal Sₒ containing odd channels. The fifth birefringent element 190 also combines even channel beams 108, 110 together to form a second output optical signal Sₑ containing even channels as shown in cross-section 10. The output optical signals Sₑ, Sₒ may be diffracted at an appropriate angle and collected by a dual-fiber collimator. The odd and even output optical signals Sₑ, Sₒ generally have different phases due to the different optical paths through the fourth birefringent element 185. Normally, this is of little consequence since the odd and even output optical signals Sₑ, Sₒ couple to different I/O ports. In applications where phase matching between the odd and even signals Sₑ, Sₒ is desired a phase compensation plate may be included between the fourth birefringent element 185 and the I/O ports 194, 195.

In the embodiment shown, the even output optical signal Sₑ couples to a first I/O port 194 and the odd output optical signal couples to a second I/O port 195. By appropriately changing the rotation of the polarizations of beams 105 and 106 at the second half waveplate 170 it is possible to direct the odd output signal Sₒ to the first I/O port 194 and the even output signal Sₑ to the second I/O port 195. Furthermore, if the second half waveplate 170 is replaced with a switchable polarization rotator, e.g. a Faraday rotator, electro-optic element, magneto-optic element, liquid crystal, or mechanically switchable waveplate, it is possible for the interleaver 100 to operate as a router or 1×2 optical switch.

In the exemplary embodiment shown in FIG. 1A the fifth birefringent element 190 has an optic axis oriented substantially parallel to the optic axis of the first birefringent element 111. This arrangement is useful in that it tends to cancel out any phase difference resulting from different optical paths for the e and o beams in the first birefringent element 111. The orientations of the birefringent elements in the interleaver 100 are not limited to the particular arrangement depicted in FIG. 1A.

To facilitate the combination of the beams 107, 108, 109, 110 a third polarization rotator 185 may be coupled between the fourth and fifth birefringent elements. The third polarization rotator 185 may contain waveplate sections 186, 188 for rotating the polarizations of beams 107, 110 by 90° as shown in cross-section 9. The polarization rotator 185 may also contain phase compensator sections 187, 189 which transmit beams 108, 109 without rotating their respective polarizations.

The interleaver 100 has been described above as operating in a demultiplexing mode. The interleaver 100 may also be operated in a multiplexing mode by receiving odd and even input signals from the I/O ports 194, 195 at the fifth birefringent element 190 and reversing the sequence of operations described above. The odd and even channels may then be combined as a multiplexed output signal at the first birefringent element 111.

An optical interleaver of the type depicted in FIGS. 1A-1B may provide stable channel separation at channel spacings less than 100 GHz. FIG. 2 depicts a theoretical plot of transmission versus signal frequency for an interleaver of the type shown in FIG. 1A. More specifically, FIG. 2 shows a theoretical calculation of the normalized transmission versus optical frequency at 50-Ghz channel spacing. The transmission curve is characterized by a series of even channel transmission peaks 202, 204, 206, 208 and odd channel transmission peaks 203, 205, 207, 209. By way of example and without loss of generality, at a channel spacing of 50 GHz the 0.5 dB bandwidth for an interleaver having a passband of the type shown in FIG. 2 is approximately 15 GHz.

Other variations on the interferometer 100 of FIGS. 1A-1B are possible. For example, it is often desirable to adjust the optical passband produced by the interleaver so that the peaks in the passband are substantially flat topped. This allows for stable operation of the interferometer in situations where there is a small amount of variation in the frequencies of the odd and even channels.

FIG. 3A depicts an optical interleaver 300 according to a second embodiment of the invention. The interleaver 300 incorporates many of the features of the interleaver 100 described above. The interleaver 300 generally comprises a polarization selective element 321, a polarization rotator 323, a first Mach-Zehnder interferometer MZI₁, a second Mach-Zehnder interferometer MZI₂ and a polarization dependent router PDR. In the embodiment depicted in FIGS. 3A-3B, the Mach-Zehnder interferometers MZI₁, MZI₂ have refractive elements optically coupled between pairs of birefringent elements as described above with respect to FIGS. 1A-1B. Other Mach-Zehnder interferometer designs are also possible.

The method of operation of the interleaver 300 is best understood by referring simultaneously to FIG. 3A and the polarization diagrams at selected cross sections depicted in FIG. 3B. One or more un-polarized signals S′ are incident on the polarization selective element 321, which may be a first birefringent element. Other birefringent polarizers, such as Nichol prisms, Glan-Thomson, or Wollaston prisms may alternatively be used. It is also possible to use a Polaroid film, Brewster's angle reflector or other linear polarizer, at the cost of incident signal intensity. The unpolarized signal S′ typically includes both vertical and horizontal components as shown in cross-section 1 of FIG. 3B. In the embodiment shown, polarization selective element 321 separates the signal S′ into a horizontally polarized extraordinary beam e′ and a vertically polarized ordinary beam o′ indicated by cross-section 2 of FIG. 3B. The WDM signal S′ typically contains one or more odd channels having frequencies ν₁, ν₃, ν₅ . . . and/or one or more even channels having frequencies ν₂, ν₄, V₆ . . . etc. The even and odd channels are typically equally spaced by some common channel spacing δν as described above.

The first birefringent element 321 is optically coupled to the polarization rotator 323. In the embodiment shown, the polarization rotator 323 includes a waveplate 324 optically coupled to circular polarizer, e.g., a quarter waveplate 325. The waveplate 324 includes a half waveplate section 326 and a phase compensation section 328. The half waveplate section 326 rotates the polarization of the ordinary beam o′ so that both the ordinary and extraordinary beams are polarized substantially parallel to each other as shown in cross-section 3 of FIG. 3B. The phase compensation section 328 compensates for any phase difference introduced by the optical path that the ordinary beam takes through the waveplate section 326. The quarter waveplate 325 has its fast-axis 327 and slow-axis 329 at 45° with respect to the ordinary beam o′ and the extraordinary beam e′. Consequently the extraordinary beam e′ and the ordinary beam o′ become circularly polarized as shown in cross-section 4 of FIG. 3B. The quarter waveplate 325 can also be replaced by other polarization rotators such as half waveplate or Faraday rotator.

The first Mach-Zehnder interferometer MZI₁ generally includes a refractive element 340 optically coupled between a second birefringent element 330 and a third birefringent element 350. The first Mach-Zehnder MZI₁ interferometer may have features in common with the Mach-Zehnder interferometer described above with respect to FIGS. 1A-1B. The refractive element 340 may passively compensate for variations in temperature or include an electro-optic element coupled to a voltage source as described above with respect to FIG. 1A. The polarization rotator 323 is optically coupled to the first Mach-Zehnder interferometer MZI₁ at the second birefringent element 330. The second birefringent element 330 further divides the two circularly polarized beams o′, e′ into two pairs of complementarily polarized components, 301, 302, and 303, 304. Complementary polarizations include orthogonal linear polarizations as shown in cross section 4 of FIG. 3B, as well as oppositely rotating circular polarizations.

Beams 301, 303 pass through the refractive element 340 while beams 302, 304 bypass the refractive element 340. The four beams 301, 302, 303, 304 then optically couple to the third birefringent element 350, which combines beam 301 with 302 and beam 303 with 304. The birefringent elements 330, 350 and the refractive element 340 contribute to an optical path difference Δ′ between beams 301 and 302 and between beams 303 and 304. The optical path difference Δ′ is related to a frequency dependent phase difference φ′ between the optical signals in beams 301, 302 and beams 303, 304. Upon recombination, the frequency dependent phase difference produces complementary polarazitions in the odd and even channels as shown in cross-section 7 of FIG. 3B and described above with respect to FIGS. 1A-1B.

The Mach-Zehnder interferometer MZI₁ thus introduces the phase difference and provides the interferences that polarize the odd and even channels in a complementary way. The odd and even polarization states are shown separately in cross sections 7-15 of FIG. 3B for the sake of clarity.

The two combined beams next couple to the second Mach-Zehnder interferometer MZI₂, which includes a second refractive element 344 optically coupled between fourth and fifth birefringent elements 385, 387. The second Mach-Zehnder interferometer MZI₂ provides additional optical isolation between the odd and even channels. In the particular embodiment shown in FIGS. 3A-3B, two polarization rotators are optically coupled to the second Mach-Zehnder interferometer MZI₂ to flatten the peaks of the passband of the interleaver 300. Specifically, a second polarization rotator 370 may be optically coupled between the first and second Mach-Zehnder interferometers MZI₂, MZI₂ and a third polarization rotator 377 may be optically coupled between the second interferometer MZI₂ and the polarization dependent rotator PDR′.

The second polarization rotator 370 has an optic axis oriented to rotate the polarizations of the odd-channel components 305 and 306 and even channel components 307 and 308 before the beams carrying them enter the second Mach-Zehnder interferometer MZI₂. The polarization rotator 370 typically rotates the polarizations by about 25° to about 35°. In the embodiment depicted in FIGS. 3A-3B, the polarization rotator rotates the polarizations of the optical signals from the first Mach-Zehnder interferometer MZI₁ counter-clockwise by about 30°. The 30° rotation orients the odd channel components 15° clockwise from the z-axis as shown in the upper portion of cross section 8 of FIG. 3B. Similarly, the even channel components are oriented at 15° clockwise from the x-axis. The second and third polarization rotators 370, 377 may alternatively be Faraday rotators, liquid crystals, magneto-optic elements, electro-optic elements, twisted nematic crystals and the like.

Because of the additional 15° rotations of the polarizations, the fourth birefringent element 385 divides the odd channel components 305 into sub-components 309, 311, and the odd channel components 306 into sub-components 313, 315. Similarly, the birefringent element 385 divides even channel components 307, 308 into sub-components 310, 312, and 314, 316 respectively as shown in cross-section 9.

The beams carrying sub-components 309, 313, 310, 314 pass through the second refractive element 344 while the beams carrying sub-components 311, 315, 312, 316 bypass the second refractive element 344. The second refractive element 344 may be configured for passive and/or active temperature compensation as described above with respect to refractive element 140 of FIG. 1A. The beams carrying all eight subcomponents 309-316 then optically couple to the fifth birefringent element 387, which combines beams carrying subcomponents 309, 313, 310, 314 with the beams carrying sub-components 311, 315, 312, and 316, respectively. The birefringent elements 385, 387 and the second refractive element 344 contribute to an optical path difference Δ″ between sub-components 309, 311 and 313, 315 and between sub-components 310, 312 and 314, 316. The optical path difference in the second stage is twice as long as the optical path difference in the first stage Δ′. Generally the phase φ″ is related to Δ″ by: φ″=2πνΔ″/c and Δ″ is related to Δ′ by Δ″=2Δ′.

By judicious choice of the thickness for the birefringent elements 330, 350 and 385, 387 and the thickness and material property for the refractive elements 340, 344, which includes the refractive index n, thermal coefficient of expansion, and the temperature coefficient of refraction dn/dT, it is possible to passively compensate for variations in optical path differences Δ′, Δ″ due to changes in temperature.

By way of example, for temperature compensation over a temperature range from ˜0°C. to ˜65° C. that limits drift in the passband of the interleaver 300 to about 3 GHz at a channel spacing δν of ˜50 GHz, if the birefringent elements 330, 350 are YVO₄ crystals of thickness ˜12 mm and refractive element 340 has a thickness between ˜1.0-˜2 mm, the preferred range for n is ˜1.45 to ˜−1.73, the preferred range for TCE is ˜5-˜9.3 ppm/° C., and the preferred range for dn/dT is ˜−0.5 to ˜5 ppm/° C. For similar temperature compensation over the same temperature range in the second Mach-Zehnder interferometer MZI₂, where the birefringent elements 385, 387 are YVO₄ crystals of thickness between 12 -15 mm, the preferred range for n is ˜1.45-˜1.73, the preferred range for TCE is ˜10-˜16 ppm/° C., the preferred thickness range for the refractive plate 344 is about ˜5.4-˜8.5 mm, and the preferred range for dn/dT is ˜−4 to ˜−6 ppm/° C. Shown in Table II are examples of potential glass materials for refractive elements 340, 344 from two leading glass suppliers.

TABLE II

| | SUPPLIER | |
|---|---|---|
| | Schott Glass Technologies | Ohara Corporation |
| | 400 York Avenue | 50 Columbia Road |
| | Duryea, PA 18642 | Somerville, NJ 08876 |
| First | FK3, BK7, K3, LaF, | S-NSL3, S-NSL5, |
| Refractive | LaK16A, LaK8, SK1 | S-TIL6, S-BAL12, |
| Element 340 | | S-BAL3, S-TIL1 |
| Second | TiF6, FK54 | S-PHM52 |
| Refractive | | |
| Element 344 | | |

The materials listed in Table II represent particular examples of materials that are currently available. The invention is in no way limited to these particular materials.

The fifth birefringent element 387 combines odd sub-components 309 and 311 to produce odd component 317, and odd sub-components 313 and 315 combine to produce odd component 319. Because of phase differences resulting from the path difference Δ″, sub-component 309 interferes with sub-component 311 and sub-component 313 interferes with sub-component 315 such that the polarizations of the odd channel components 317, 319 are tilted by 15° with respect to the z-axis as shown in the upper portion of cross-section 11. Similarly the fifth birefringent element 387 combines even-channel sub-component 310 with 312 and sub-component 314 with 316 which interfere to form a beam having even channel components 318, 320 having polarizations tilted by 15° with respect to the x-axis as shown in the lower portion of cross-section 15. The tilting of the polarization by the second polarization rotator 370 and the frequency dependent interference produced by the second Mach-Zehnder interferometer MZI₂ tends to flatten the peaks of optical passband and widen the gaps of optical stopband associated with the interferometer 300.

A third polarization rotator 377 may then rotate the linear polarization states of beams 317-320 clockwise by 15°. Although optional, this step is often desirable so that the polarizations of either the even or odd channels align with either the x-axis or the z-axis as shown in cross sections 12 of FIG. 3B. The odd and even channels can then be separated by the polarization-dependent router PDR′. In the embodiment depicted in FIG. 3A, the polarization dependent router PDR′ includes a sixth birefringent element 390, a fourth polarization rotator 379 and a seventh birefringent element 392. The sixth birefringent element 390, separates the beams containing the odd channel components 317, 319 and the even 318, 320 channel components into two odd-channel beams and two even-channel beams as shown in cross section 13. The fourth polarization rotator 379 may be divided into waveplate sections and phase compensation sections as described above with respect to polarization rotator 185 of FIG. 1A. The waveplate sections rotate the polarizations of the components 318, 319 by 90° as shown in cross-section 14 of FIG. 3B. The phase compensation sections provide an optical path that matches the optical path through the waveplate sections. The seventh birefringent element 392 then combines the beams containing the odd channel components 317, 319 together to form an output optical signal Sₒ′ containing odd channels. The seventh birefringent element 392 also combines the beams containing the even channel components 318, 320 to form an even output optical signal Sₑ′ containing even channels as shown in cross-section 15. The output optical signals Sₑ′, Sₒ′ may be diffracted at an appropriate angle and collected by a dual-fiber collimator.

The interleaver 300 has been described above as operating in a demultiplexing mode. The interleaver 300 may alternatively be operated in a multiplexing mode by starting with odd and even input signals at the seventh birefringent element 392 and reversing the direction of operation. The odd and even channels may then be combined as a multiplexed output signal at the first birefringent element 321. Furthermore, the interleaver 300 may also operate in a routing or 1×2 switch mode, e.g., if the third polarization rotator 377 is replaced with a switchable polarization rotator.

An interleaver of the type described with respect to FIGS. 3A-3B may provide stable channel separation at channel spacings less than 100 GHz. FIG. 4 depicts a theoretical plot of transmission versus signal frequency for an interleaver of the type shown in FIG. 3A. More specifically, FIG. 4 shows a theoretical calculation of the normalized transmission versus optical frequency at 50-Ghz channel spacing.

The transmission curve is characterized by a series of even channel transmission peaks 402, 404, 406, 408 and odd channel transmission peaks 403, 405, 407, 409. The peaks in FIG. 4 are flattened and the gaps between channels widened compared to the peaks and gaps in FIG. 2 due to the effect of the second Mach-Zehnder interferometer MZI₂. Consequently there is little loss of transmission due to the rounded shape of the transmission peaks if the frequency drifts by a few GHz. By way of example and without loss of generality, at a channel spacing of 50 GHz the 0.5 dB bandwidth for an interleaver having a passband of the type shown in FIG. 4 is approximately 24.7 GHz. The flattening of the peaks is somewhat dependent on the amount of rotation induced by the second Mach-Zehnder interferometer MZI₂. In the example depicted in FIGS. 3A-3B, the second Mach-Zehnder interferometer MZI₂ introduced a 15° rotation. The invention is in no way limited to this particular amount of rotation. A greater or lesser amount of rotation may alternatively be used depending on the desired amount and type of peak shaping desired.

Other variations are possible on the basic interleavers described above. For example, FIG. 5 depicts an isometric schematic diagram of an alternative embodiment of a Mach-Zehnder interferometer 500 that may be used as the interferometer MZI of FIG. 1A, or the first and/or second interferometers MZI₁, MZI₂ of FIG. 2A. The interferometer 500 generally comprises a refractive element 540 and a polarization rotator 560 optically coupled between a first birefringent element 530 and a second birefringent element 550. Preferably, the first and second birefringent elements are made from the same material, e.g., YVO₄, and have the same thickness L. In the embodiment depicted in FIG. 5, the polarization rotator 560 is a half waveplate having an optic axis oriented at 45° to the z and x axes. The polarization rotator 560 is thus configured to rotate the polarization of horizontally (x-axis) and vertically (z-axis) polarized light by 90°. The polarization rotator 560, and other half waveplates described above, may alternatively be any other type of polarization rotation device such as a Faraday rotator, liquid crystal, twisted nematic crystal, Kerr Cell, electro-optic device, magneto optic device and the like. Although a 90° rotation is shown and described herein because of the choice of orientation of the optic axes of the birefringent elements, other rotations are possible, including no rotation at all.

The interferometer 500 operates as follows. The first birefringent element 530 receives optical signals 501, 502 e.g., from the output of polarization rotator 120 in FIG. 1A where 501,502 can either be circular-polarized or linear-polarized at 45° with respect to the z-axis. The first birefringent element 530 separates beams 501 and 502 into ordinary components 503, 504 and extraordinary components 505, 506. The ordinary component 503 and the extraordinary component 505 have the same intensity. Similarly, the ordinary component 504 and the extraordinary component 506 have the same intensity. Components 503, 504 may have different intensities. Components 505, 506 may likewise have different intensities. The ordinary component 503 and extraordinary components 504 have the same intensity. In the exemplary embodiment shown in FIG. 5, optical signals polarized along the z-axis are extraordinary rays in the first and second birefringent element 530, 550. The first birefringent element thus walks off an extraordinary beam 505 from ordinary beam 503 and extraordinary beam 506 from ordinary beam 504 by an angle a. Beams 505, 506 travel a longer optical path through the first birefringent element than beams 503, 504 as described above with respect to FIG. 1A. The resulting optical path difference may be compensated as follows. The polarization rotator 560 rotates the polarizations of all four beams 503, 504, 505, 506. If the optic axis of the second birefringent element 550 is oriented substantially parallel to the optic axis of the first birefringent element 530, beams 503, 504 become ordinary rays and beams 505, 506 become extraordinary rays in the second birefringent element 550. Beams 503, 504 are then refracted at an angle a and travel a longer optical path than beams 505, 506. If the first and second birefringent elements 530, 550 have the same thickness L optical path difference due to the first birefringent element 530 cancels the optical path difference due to the second birefringent element 550. Because the optical path difference contributions due to the birefringent elements 530, 550 tend to cancel out, the optical path difference between the two arms of the interferometer 500 is, therefore, just that due to the refractive element 540.

The exemplary refractive element 540 has a first section 542 of thickness L₁ and a second section 544 of thickness L₂, where L₁ and L₂ are measured along the z-axis. The two sections 542, 544 may optionally be made of different materials such that they have different material properties, e.g., refractive indexes n₁, n₂, temperature coefficients of refraction α₁, α₂, temperatures coefficients of expansion k₁, k₂. The first and second sections provide different optical paths that act as the sample and reference arms of the Mach-Zehnder interferometer 500. The optical path difference Δ is then given by n₁L₁-n₂L₂. It is also possible to dispense with one of the two sections, e.g., the second section 544, such that one of the beam paths passes through free space, in which case Δ=(n₁−1)L₁. The optical path difference A is related to a phase difference φ between the optical signals in beams 503, 504 and beams 505, 506 as described above.

The optical path difference Δ is in general dependent on environmental temperature variation because both refractive index and length tend to change with temperature. To first order, refractive index and length depend linearly on temperature over a certain temperature range T₀-T₁.

Specifically, the temperature coefficient of expansion (TCE), k₁, k₂ for the first and second sections may be defined by the following equations,

L₁=L₁₀+k₁L₁₀(T−T₀)

L₂=L₂₀+k₂L₂₀(T−T₀),

where L₁₀ and L₂₀ are the lengths of the first and second sections 142, 144 respectively at a reference temperature T₀.

In a like manner, the linear temperature coefficients, α₁ and α₂, of the refractive indexes n₁, n₂ may be defined by:

n₁=n₁₀+α₁(T−T₀);

and

n₂=n₂₀+α₂(T−T₀),

where n₁₀ and n₂₀ are the refractive indexes at T₀ for sections 142 and 144, respectively.

For changes in optical path difference with temperature to cancel out δ(n₁L₁−n₂L₂)=0 If terms of order (T−T₀)² and higher in the optical path difference n₁L₁−n₂L₂ are substantially small and negligible the previous equation becomes:

(n₁₀k₁L₁₀+α₁L₁₀−n₂₀k₂L₂₀−α₂₁L₂₀)δT=0

Thus, for non-zero δT, its coefficient ( ) should be equal to zero. In such a case, the relation between L₁₀ and L₂₀ at temperature T₀ is given by:

$$\frac{{L}_{10}}{{L}_{20}} = \frac{{α}_{2} + {n}_{20} {k}_{2}}{{α}_{1} + {n}_{10} {k}_{1}}$$

If the lengths L₁₀ and L₂₀ are chosen according to the above equation, the linear temperature dependence term in the optical path difference can be eliminated. It will be clear to one skilled in the art that the above embodiments may be altered in many ways without departing from the scope of the invention. Accordingly, the scope of the invention should be determined by the following claims and their legal equivalents.

What is claimed is:

1. An optical interleaver apparatus, comprising:
a) a first birefringent element having an optic axis oriented to split an input optical signal into an ordinary beam having a first polarization and an extraordinary beam having a second polarization;
b) a polarization rotator optically coupled to the first birefringent element; for rotating one or more of the first and second polarizations such that the ordinary and extraordinary beams have substantially parallel polarizations;
c) a quarter waveplate optically coupled to the first birefringent element, the quarter waveplate having fast and slow axes oriented to circularly polarize the ordinary and extraordinary beams;
d) a second birefringent element optically coupled to the quarter waveplate, the second birefringent element having an optic axis oriented such that the second birefringent element separates the ordinary beam into first and second beams having equal intensity and complementary polarizations and whereby the second birefringent element separates the extraordinary beam into third and fourth beams having equal intensity and complementary polarizations;
e) a refractive element, optically coupled to the second birefringent element that contributes to an optical path difference between the first beam and the second beam and contributes to an optical path difference between the third beam and the fourth beam, wherein the optical path difference introduces a frequency dependent phase difference between one or more channels in the first and second beams, and wherein the optical path difference causes a frequency dependent phase difference between one or more channels in the third and fourth beams; and
f) a third birefringent element optically coupled to the refractive element, whereby the third birefringent element combines the first and second beams to form a fifth beam and whereby the third birefringent element combines the third and fourth beams to form a sixth beam, wherein the frequency dependent phase difference produces an interference in the fifth and sixth beams such that even and odd channels in the fifth and sixth beams have complementary polarizations.

2. The apparatus of claim 1, wherein a phase difference between odd and even channels is substantially equal to π radians.

3. The apparatus of claim 1 wherein the refractive element has a thickness, index of refraction, temperature coefficient of expansion and temperature coefficient of refraction selected such that a change in thickness and index of refraction of the refractive element with temperature compensates for a change in the optical path difference between the two arms due to change in temperature.

4. The apparatus of claim 1 wherein the refractive element includes means for actively compensating for changes in optical path due to change in temperature.

5. The apparatus of claim 1, further comprising a polarization rotator for rotating the polarizations of the fifth and sixth beams.

6. The apparatus of claim 5, wherein the polarization rotator is a switchable polarization rotator.

7. The apparatus of claim 5, wherein the polarization rotator comprises a second half waveplate having an optic axis aligned at about 22.5° with respect to a polarization of one of the first, second, third, and fourth beams.

8. The apparatus of claim 7 further comprising a fourth birefringent element, optically coupled to the second half waveplate, whereby the fourth birefringent element separates the fifth beam into an seventh beam and an eighth beam having orthogonal polarizations, and whereby the fourth birefringent element separates the sixth beam into a ninth beam and a tenth beam having orthogonal polarizations.

9. The apparatus of claim 8 further comprising a third polarization rotator optically coupled to the fourth birefringent element.

10. The apparatus of claim 9 further comprising a fifth birefringent element optically coupled to the third polarization rotator, the fifth birefringent element having an optic axis oriented substantially parallel to the optic axis of the first birefringent element, whereby the fifth birefringent element combines the seventh and ninth beams into a first output signal containing a first subset of channels and wherein the fifth birefringent element combines the eighth and tenth beams into a second output signal containing a second subset of alternate channels.

11. The apparatus of claim 9 wherein the third polarization rotator includes first and second rotating segments for rotating the polarizations of the seventh and tenth beams.

12. An optical interleaver method, comprising the steps of:
a) polarizing an optical signal containing one or more odd channels and/or one or more even channels;
b) rotating a polarization of the optical signal;
c) separating the optical signal into two or more complementarily polarized beams of equal intensity;
d) introducing an optical path difference between the two or more complementarily polarized beams;
e) combining the two or more complementarily polarized beams such that they interfere to form one or more combined beams, wherein any odd channels in the one or more combined beams have complementary polarizations to any even channels in the one or more combined beams;
f) separating the odd and even channels according to their polarizations,
wherein steps c) through e) are performed by a Mach-Zehnder interferometer.

13. The method of claim 12, wherein step a) includes separating the optical signal into complementarily polarized ordinary and extraordinary beams containing both odd and even channels.

14. The method of claim 12, wherein step d) includes compensating for changes in optical path due to changes in temperature.

15. The method of claim 14, wherein the compensating step d) includes passing at least one of the two or more complementary polarized beams through a refractive element having a thickness, index of refraction, temperature coefficient of expansion, and temperature coefficient of refraction selected such that the optical path difference remains substantially constant over a predetermined temperature range.

16. The method of claim 12, wherein step b) includes circularly polarizing the optical signal.

17. The method of claim 16, wherein step c) includes separating the circularly polarized optical signal into complementarily polarized first and second beams containing both odd and even channels, and separating the circularly polarized optical signal into complementarily polarized third and fourth beams containing both odd and even channels.

18. The method of claim 17, wherein step d) includes introducing an optical path difference between the first beam and the second beam and introducing an optical path difference between the third beam and the fourth beam.

19. The method of claim 18 wherein step e) includes combining the first and second beams such that the first and second beams interfere to form a fifth beam containing both odd and even channels and combining the third and fourth beams such that the third and fourth beams interfere to form a sixth beam containing both odd and even channels.

20. The method of claim 19 wherein step f) includes rotating the polarizations of the odd and even channels in the fifth and sixth beams.

21. The method of claim 20 wherein step f) includes separating the fifth beam into seventh and eighth beams having complementary polarizations and separating the sixth beam into ninth and tenth beams having complementary polarizations, wherein the seventh and ninth beams contain one ore more of the odd channels and the eighth and tenth beams contain one or more of the even channels.

22. The method of claim 21 further comprising the step of combining the seventh beam with the ninth beam to form an odd output signal and combining the eighth beam with the tenth beam to form an even output signal.

23. The method of claim 22 further comprising the step of selectively routing the even and odd output signals to first and second I/O ports.

24. An optical interleaver apparatus, comprising:
a) means for linearly polarizing an optical signal containing one or more odd channels;
b) means for rotating a polarization of the optical signal;
c) means for separating the optical signal into two or more complementarily polarized beams of equal intensity;
d) means for introducing an optical path difference between the two or more complementarily polarized beams;
e) means for combining the two or more complementarily polarized beams such that the beams interfere to form one or more combined beams, wherein any odd channels in the one or more combined beams have complementary polarizations to any even channels in the one or more combined beams; and
f) means for separating the odd and even channels according to their polarizations;
wherein means c) through e) are a Mach-Zehnder interferometer.

25. The apparatus of claim 24 wherein the means for rotating a polarization includes a circular polarizer.

26. The apparatus of claim 24 wherein the means for introducing an optical path difference includes means for compensating for changes in optical path through one or more of the separating means, optical path difference introducing means and combining means due to changes in temperature.

27. The apparatus of claim 26 wherein the means for compensating includes a refractive element made from a material having a length of between about 1.0 and about 2 mm, a refractive index of between about 1.45 and about 1.73, a temperature coefficient of expansion (TCE) of between about 5 and about 9.3 ppm/° C., and a temperature coefficient of refraction (dn/dT) of between about −0.5 and about 5 ppm/° C.

28. The apparatus of claim 24, wherein the means for introducing an optical path difference includes a refractive plate having a first section with a first thickness L₁ and a second section with a second thickness L₂.

29. The apparatus of claim 28 wherein optical path differences between the two complementary polarized beams due to the means for separating and the means for combining substantially cancel each other out.

30. The apparatus of claim 29, wherein the first section has a first refractive index n₁ and the second section has a second refractive index n₂, wherein the first and second refractive indexes, n₁ and n₂ are different, wherein the first section has a first temperature coefficients of expansion and refraction α₁, k₁ and the second section has temperature coefficients of expansion and refraction α₂, k₂, and wherein L₁, L₂, n₁, n₂, α₁, α₂, k₁, k₂ are selected such that an optical path difference between the two sections remains constant over a predetermined temperature range.

31. The apparatus of claim 24, further comprising means for selectively routing output signals containing one or more of the even channels and output signals containing one or more of the odd channels to first and second I/O ports.

32. The apparatus of claim 31 wherein the means for selectively routing includes an electro-optic element incorporated into the refractive element.

33. The apparatus of claim 32, wherein the means for selectively routing includes a switchable polarization rotator optically coupled between the means for combining and the means for separating the odd and even channels.

34. An optical interleaver apparatus, comprising:
a) a polarization selective element;
b) a polarization rotator, optically coupled to the polarization selective element; and
c) a first Mach-Zehnder interferometer optically coupled to the polarization rotator.

35. The apparatus of claim 34, wherein the Mach-Zehnder interferometer includes a refractive element optically coupled between two birefringent elements, wherein the refractive element contributes to an optical path difference between two arms of the interferometer.

36. The apparatus of claim 35, wherein the refractive element has a thickness, index of refraction, temperature coefficient of expansion and temperature coefficient of refraction selected such that a change in thickness and index of refraction of the refractive element with temperature compensates for a change in the optical path difference between the two arms due to change in temperature.

37. The apparatus of claim 36, wherein the refractive element is made from a material having a length of between about 1.0 and about 2 mm, a refractive index of between about 1.45 and about 1.73, a temperature coefficient of expansion (TCE) of between about 5 and about 9.3 ppm/° C., and a temperature coefficient of refraction (dn/dT) of between about −0.5 and about 5 ppm/° C.

38. The apparatus of claim 34 wherein the first and second birefringent elements and the refractive element all contribute to an optical path difference between to arms of the Mach-Zehnder interferometer.

39. The apparatus of claim 34 wherein an optical path difference due to the first birefringent element substantially cancels an optical path difference due to the second birefringent element.

40. The apparatus of claim 34, wherein the refractive element comprises first and second sections, wherein the first and second sections have different thicknesses and different material properties.

41. The apparatus of claim 40, wherein the first and second sections have thicknesses, thermal coefficients of expansion, refractive indexes and temperature coefficients of refraction chosen such that changes with temperature of the respective thicknesses and refractive indexes of the first and second sections keep an optical path difference for optical signals traveling through the Mach-Zehnder interferometer substantially constant over a predetermined temperature range.

42. The apparatus of claim 34 further comprising a polarization dependent router optically coupled to the Mach-Zehnder interferometer.

43. The apparatus of claim 42, further comprising first and second I/O ports optically coupled to the polarization dependent router and means for selectively routing output signals containing one or more odd channels and output signals containing one or more even channels to the first and second output ports.

44. The apparatus of claim 43, wherein the means for selectively routing includes a switchable polarization rotator optically coupled between the Mach-Zehnder interferometer and the polarization dependent router.

45. The apparatus of claim 34, further comprising a second Mach-Zehnder interferometer optically coupled to the first Mach-Zehnder interferometer.

46. The apparatus of claim 45, wherein the second Mach-Zehnder interferometer includes a second refractive element optically coupled between first and second birefringent elements.

47. The apparatus of claim 46, wherein the second refractive element has a thickness, index of refraction, temperature coefficient of expansion and temperature coefficient of refraction selected such that a change in thickness and index of refraction of the second refractive element with temperature compensates for a change in the optical path difference between two arms of the second Mach-Zehnder interferometer due to change in temperature.

48. The apparatus of claim 45, further comprising a second polarization rotator optically coupled between the first and second Mach-Zehnder interferometers and a third polarization rotator optically coupled after the second Mach-Zehnder interferometer.

49. The apparatus of claim 48, wherein the second polarization rotator rotates the polarization of optical signals from the first Mach-Zehnder interferometer by about 30°.

50. The apparatus of claim 49, wherein the third polarization rotator rotates the polarization of optical signals from the second Mach-Zehnder interferometer by about 15°.
